(19) United States
(12) Patent Application Publication
(10) Pub. No.: US 2026/0112831 A1
(43) Pub. Date: Apr. 23, 2026

(54) ELECTRICAL CONNECTOR AND METHOD OF MANUFACTURING ELECTRICAL CONNECTOR

(71) Applicant: SUMITOMO ELECTRIC INDUSTRIES, LTD., Osaka (JP)

(72) Inventors: Masaki SUZUKI, Osaka (JP); Takeshi INOUE, Osaka (JP)

(73) Assignee: SUMITOMO ELECTRIC INDUSTRIES, LTD., Osaka (JP)

(21) Appl. No.: 19/359,799

(22) Filed: Oct. 16, 2025

(30) Foreign Application Priority Data
Oct. 18, 2024 (JP) 2024-182562

(51) Int. Cl. H01R 12/77; H01R 43/28

(52) U.S. Cl. CPC H01R 12/772; H01R 43/28

(57) ABSTRACT

An electrical connector according to an embodiment of the present disclosure includes a first electrical wire extending along a first direction and including a conductor and an insulating sheath covering the conductor, and a housing provided with a first groove that extends along the first direction to accommodate and hold the first electrical wire, a depth direction of the first groove being a second direction intersecting the first direction. A side surface of the conductor of the first electrical wire located at the first groove includes a first portion accommodated inside the first groove and a second portion located outside the first groove, the first portion is exposed from the sheath, and at least part of the second portion is covered with the sheath.

### CROSS REFERENCE TO RELATED APPLICATIONS

This application claims priority based on Japanese Patent Application No. 2024-182562 filed on October 18, 2024, and the entire contents of the Japanese patent application are incorporated herein by reference.

### TECHNICAL FIELD

The present disclosure relates to an electrical connector and a method of manufacturing an electrical connector.

### BACKGROUND

Patent Literature 1 (Japanese Unexamined Patent Application Publication No. 2017-069166) discloses an example of an electrical connector connectable to a mating electrical connector. In this electrical connector, each of a plurality of conductive wires is inserted into a corresponding through-hole of a plurality of through-holes provided in a housing and fixed therein.

### SUMMARY

An electrical connector according to an embodiment of the present disclosure includes a first electrical wire extending along a first direction and including a conductor and an insulating sheath covering the conductor, and a housing provided with a first groove that extends along the first direction to accommodate and hold the first electrical wire, a depth direction of the first groove being a second direction intersecting the first direction. A side surface of the conductor of the first electrical wire located at the first groove includes a first portion accommodated inside the first groove and a second portion located outside the first groove, the first portion is exposed from the sheath, and at least part of the second portion is covered with the sheath.

### BRIEF DESCRIPTION OF THE DRAWINGS

FIG. 1 is a perspective view of an electrical connector according to a first embodiment of the present disclosure as viewed from front.

FIG. 2 is a perspective view of an electrical connector as viewed from rear.

FIG. 3 is a partially enlarged view of FIG. 2.

FIG. 4 is a cross-sectional view of a part of a stepped supporting portion, showing a conductor of an electrical wire inserted into each of holding holes.

FIG. 5 is a cross-sectional view taken along line V-V of FIG. 4, showing a cross section of an electrical wire accommodated in a groove.

FIG. 6 is a flowchart showing an example of a method of manufacturing an electrical connector according to a present embodiment.

FIG. 7 is a cross-sectional view of a first modification of the present disclosure, showing a cross section of an electrical wire accommodated in a groove, perpendicular to the X direction.

FIG. 8 is a cross-sectional view of an electrical connector according to a second modification of the present disclosure.

FIG. 9 is a cross-sectional view of an electrical connector according to a third modification of the present disclosure.

FIG. 10 is a cross-sectional view of a fourth modification of the present disclosure, showing a cross section of a flexible flat cable disposed on an introducing portion, perpendicular to the X direction.

FIG. 11 is a cross-sectional view of an electrical connector according to a comparative example.

### DETAILED DESCRIPTION

In an electrical connector of a type in which an electrical wire is inserted into a through hole, there is an electrical connector in which a sheath of a tip end portion of the electrical wire is removed to expose a conductor, and the exposed portion of the conductor is inserted into the through hole. In order to facilitate work of inserting the conductor into the through hole, a groove for guiding the conductor into the through hole may be provided at the rear of the through hole. The groove is formed in an insulating member.

For example, as described above, when the conductor exposed from the sheath in the electrical connector is disposed in the groove, a side surface of the conductor exposed from the groove is not covered with the insulator such as the sheath or the insulating member described above, and is exposed to air. Due to the difference in dielectric constants between the insulator and air, the impedance of the conductor changes in the portion, leading to deterioration or variation of the characteristic impedance of the electrical wire. The deterioration or variation of the characteristic impedance causes reflection or crosstalk of a signal transmitted in the conductor.

An object of the present disclosure is to provide an electrical connector and a method of manufacturing the electrical connector, which can reduce the degree of deterioration or variation of the characteristic impedance of the electrical wire.

### [Description of Embodiments of Present Disclosure]

First, the contents of the embodiments of the present disclosure will be listed and described.

[1] An electrical connector according to an embodiment of the present disclosure includes a first electrical wire extending along a first direction and including a conductor and an insulating sheath covering the conductor, and a housing provided with a first groove that extends along the first direction to accommodate and hold the first electrical wire, a depth direction of the first groove being a second direction intersecting the first direction. A side surface of the conductor of the first electrical wire located at the first groove includes a first portion accommodated inside the first groove and a second portion located outside the first groove, the first portion is exposed from the sheath, and at least part of the second portion is covered with the sheath.

In the electrical connector of the above [1], the side surface of the conductor of the first electrical wire located at the first groove includes the first portion accommodated inside the first groove, and the first portion is exposed from the sheath. This makes it possible to accurately guide the conductor. In addition, the side surface of the conductor of the first electrical wire located at the first groove includes the second portion located outside the first groove, and at least part of the second portion is covered with the sheath. This reduces the change in the impedance of the conductor, thereby reducing the degree of deterioration or variation of the characteristic impedance of the first electrical wire.

[2] In the electrical connector of the above [1], the housing may be further provided with a first holding hole extending along the first direction to pass through the housing. The first holding hole may have a first end contiguous to the first groove. The first holding hole may accommodate a portion of the conductor exposed from the sheath at a tip end portion of the first electrical wire and may hold the first electrical wire such that a tip end of the conductor is exposed at a second end of the first holding hole. In this case, the conductor can be accurately guided to the first holding hole by the first groove. Thus, the assembling work of the first electrical wire and the housing is facilitated.

[3] The electrical connector of the above [2] may further include a second electrical wire extending along the first direction and including a conductor and an insulating sheath covering the conductor. The housing may be further provided with a second groove that extends along the first direction to accommodate and hold the second electrical wire, a depth direction of the second groove being the second direction. The housing may be further provided with a second holding hole that extends along the first direction to pass through the housing and the second holding hole may be located in the second direction relative to the first holding hole. The second holding hole may have a first end contiguous to the second groove. A side surface of the conductor of the second electrical wire located at the second groove includes a first portion accommodated inside the second groove and a second portion located outside the second groove, the first portion may be exposed from the sheath, and at least part of the second portion may be covered with the sheath. In this case, the conductor can be accurately guided to the second holding hole by the second groove. Thus, the assembling work of the second electrical wire and the housing is facilitated. In addition, the electrical wires can be disposed over a plurality of stages. Thus, the packaging density of the electrical wires can be increased.

[4] In the electrical connector according to any one of the above [1] to [3], the first electrical wire may be a flexible flat cable. For example, in this manner, even in the electrical connector provided with the flexible flat cable, the degree of deterioration or variation of the characteristic impedance can be reduced by reducing the change in the impedance of the conductor.

[5] In the electrical connector according to any one of the above [1] to [4], in a cross section perpendicular to the first direction of the first electrical wire, a portion of an outer periphery of the conductor covered with the sheath may be longer than a portion of the outer periphery of the conductor exposed from the sheath. When the first groove is shallow, the second portion located outside the first groove is larger than the first portion accommodated in the first groove. In such a case, when the second portion is exposed from the sheath, the change in the impedance of the conductor becomes large, and the degree of deterioration or variation of the characteristic impedance of the first electrical wire becomes large. As in the electrical connector of the above [5], by providing the sheath over a sufficient length of the outer periphery of the conductor, it is possible to reduce the change in the impedance of the conductor and reduce the degree of deterioration or variation of the characteristic impedance of the first electrical wire.

[6] A method of manufacturing the electrical connector according to an embodiment of the present disclosure is a method of manufacturing the electrical connector according to any one of the above [1] to [5]. The method of manufacturing the electrical connector includes: fabricating the first electrical wire by preparing an electrical wire including a conductor and an insulating sheath covering the conductor and by removing a portion of the sheath covering the first portion while leaving a portion of the sheath covering the at least part of the second portion; and accommodating the first electrical wire in the first groove such that the first portion is accommodated inside the first groove. According to this manufacturing method, it is possible to easily fabricate the first electrical wire in which the first portion accommodated inside the first groove is exposed from the sheath and at least part of the second portion located outside the first groove is covered with the sheath.

### Details of Embodiments of Present Disclosure

Specific examples of the present disclosure are described below with reference to the drawings. The present invention is not limited to the examples, but is indicated by the claims, and is intended to include all modifications within the meaning and scope equivalent to the claims. In the following description, the same elements are denoted by the same reference signs in the description of the drawings, and a repeated description is omitted.

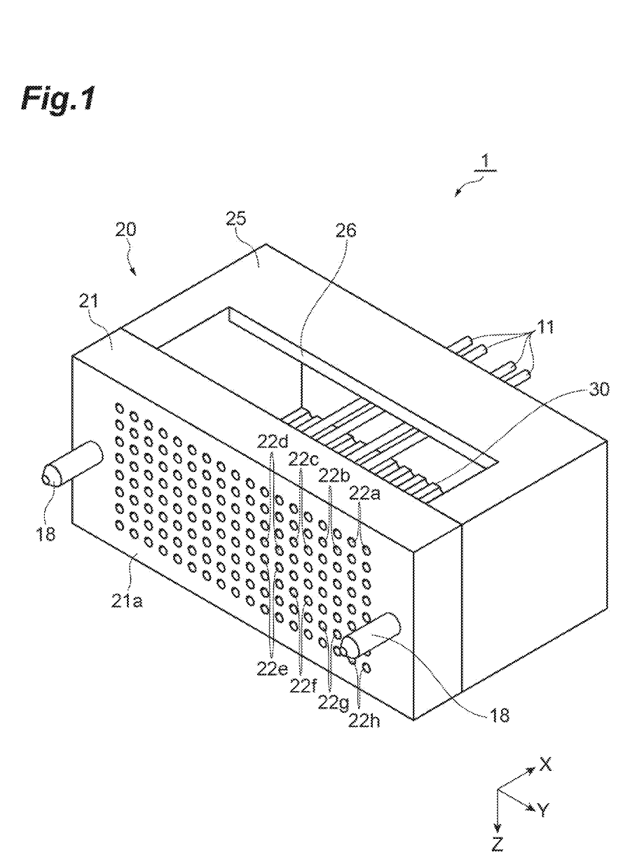

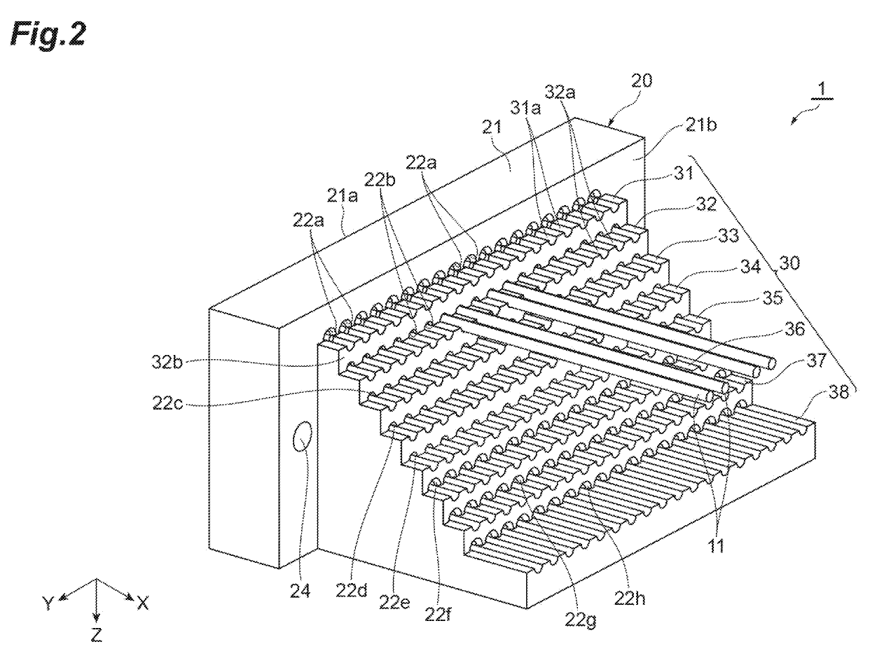

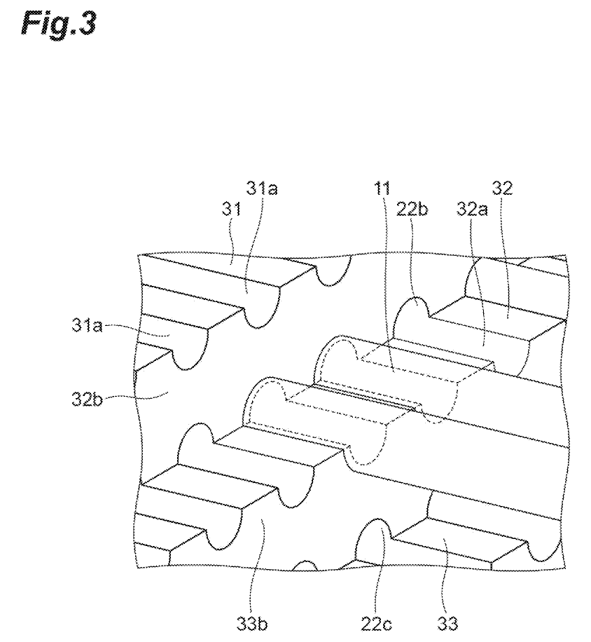

FIG. 1 is a perspective view of an electrical connector 1 according to a first embodiment of the present disclosure as viewed from front. FIG. 2 is a perspective view of the electrical connector 1 as viewed from behind. FIG. 3 is a partially enlarged view of FIG. 2. In FIGS. 1, 2, and 3, only some of electrical wires 11 are shown, and the other electrical wires 11 are omitted. As shown in these drawings, the electrical connector 1 includes the plurality of electrical wires 11, a pair of guiding pins 18, and a housing 20. The pair of guiding pins 18 performs positioning when the electrical connector 1 is connected to a mating connector. The housing 20 holds the plurality of electrical wires 11. Each guiding pin 18 is press-fitted into a respective guiding hole 24 (see FIG. 2) provided in the housing 20.

The plurality of electrical wires 11 are members for transmitting electric power or electric signals. The plurality of electrical wires 11 each extend along an X direction (first direction) and are arranged along a Y direction intersecting (for example, orthogonal to) the X direction. The number of electrical wires 11 is not particularly limited. Each electrical wire 11 includes a conductor having conductivity and an insulating sheath for covering the conductor. The sheath is made of resin, for example. The conductor is, for example, a metal such as copper. The conductor is connected to a circuit or the like of a board via a terminal provided on the mating connector when the electrical connector 1 is connected to the mating connector.

The conductor of the tip end portion of each electrical wire 11 is accommodated in any one of holding holes 22a to 22h provided in the housing 20. At this time, the tip end of each electrical wire 11 is exposed to the outside on a front surface 21a of the housing 20. Thus, each of the plurality of electrical wires 11 is connected to the terminal of the mating connector. Each electrical wire 11 may be a signal line or a ground line.

The housing 20 is a member that holds the plurality of electrical wires 11 such that the tip end of each electrical wire is exposed to the front (front surface 21a) of the electrical connector 1. The housing 20 has a housing front end portion 21, a housing back end portion 25 and a stepped supporting portion 30, as shown in FIGS. 1 and 2. The housing 20 is formed of a resin that can be precisely molded, such as polyphenylene sulfide (PPS) or liquid crystal polymer (LCP). The housing front end portion 21, the housing back end portion 25 and the stepped supporting portion 30 may be integrally formed or may be attached to each other after each is formed.

The housing front end portion 21 is a portion that mainly holds the plurality of electrical wires 11, and is a plate-shaped member including the front surface 21a and a back surface 21b. Each of the left edge and the right edge of the housing front end portion 21 is provided with the guiding hole 24 for press-fitting the guiding pin 18. The guiding hole 24 passes through the housing front end portion 21 from the front surface 21a toward the back surface 21b.

The housing front end portion 21 and the stepped supporting portion 30 are provided with the plurality of holding holes 22a (first holding hole), a plurality of holding holes 22b (second holding hole), a plurality of holding holes 22c, a plurality of holding holes 22d, a plurality of holding holes 22e, a plurality of holding holes 22f, a plurality of holding holes 22g, and a plurality of holding holes 22h, which are through holes. Each of the holding holes 22a to 22h holds a corresponding electrical wire of the plurality of electrical wires 11. The plurality of holding holes 22a, each extending along the X direction to pass through the housing front end portion 21, are arranged along the Y direction. Each of the plurality of holding holes 22a has a back end (first end) opening on the back surface 21b of the housing front end portion 21.

The plurality of holding holes 22b each extends along the X direction to pass through the housing front end portion 21 and the stepped supporting portion 30, and are arranged along the Y direction. The plurality of holding holes 22b is placed below the plurality of holding holes 22a in the Z direction intersecting (for example, orthogonal to) both the X direction and the Y direction. As in the plurality of holding holes 22b, the plurality of holding holes 22c to the plurality of holding holes 22h each extends along the X direction to pass through the housing front end portion 21 and the stepped supporting portion 30, and are arranged along the Y direction. The plurality of holding holes 22c to the plurality of holding holes 22h are placed in order below the plurality of holding holes 22b in the Z direction. Since the housing 20 has the stepped supporting portion 30 having a staircase-like shape, the lengths of the plurality of holding holes 22a to the plurality of holding holes 22h along the X direction sequentially increase. That is, the length of the plurality of holding holes 22a is the shortest, the lengths of the plurality of holding holes 22b, 22c, 22d, 22e, 22f, 22g, and 22h gradually become longer in this order, and the length of the plurality of holding holes 22h is the longest. The plurality of holding holes 22b to 22h except the plurality of holding holes 22a have back ends (first ends) opening on walls of respective introducing portions 32–38 of the stepped supporting portion 30 (for example, a wall 32b of the introducing portion 32). The conductor of each tip end portion of the plurality of electrical wires 11 is accommodated in a corresponding holding hole of the plurality of holding holes 22a to 22h.

Further, a front end (second end) of each of the plurality of holding holes 22a to 22h is open on the front surface 21a of the housing front end portion 21. Each of the plurality of holding holes 22a to 22h holds a corresponding one of the electrical wires 11 so that each tip end of the plurality of accommodated electrical wires 11 is exposed on the front surface 21a of the housing front end portion 21.

The housing back end portion 25 is a hollow portion surrounding the stepped supporting portion 30, and is formed to define a space in the inside such that an upper part of the stepped supporting portion 30 is open. The housing back end portion 25 is provided with a window portion 26 so that an operator or the like can visually recognize at least some (preferably, half or more) of the introducing portions 31–38 of the stepped supporting portion 30. By such window portion 26 being provided, when the operator inserts each electrical wire 11 into the holding holes 22a to 22h of the housing 20, the operator can easily observe the condition of the electrical wire 11 and proceed with the work.

The stepped supporting portion 30 is a staircase-like portion for guiding each of the plurality of electrical wires 11 to each of the plurality of holding holes 22a to 22h while holding the plurality of electrical wires 11. The stepped supporting portion 30 has eight introducing portions 31, 32, 33, 34, 35, 36, 37, and 38 as shown in FIG. 2. However, the number of the introducing portions provided in the stepped supporting portion 30 is not limited thereto, and it is sufficient that one or more introducing portions be provided, two or more introducing portions may be provided, or four or more introducing portions may be provided.

The introducing portion 31 is a portion extending along the X direction and the Y direction, and is provided with a plurality of grooves 31a (first grooves) on an upper surface thereof. Each of the plurality of grooves 31a is formed in the Z direction as a depth direction, extends in the X direction, and is arranged along the Y direction. Each groove 31a is contiguously formed to lead to the corresponding holding hole 22a. The groove 31a accommodates and holds the electrical wire 11 introduced into the holding hole 22a, and guides the electrical wire 11. The groove 31a has, for example, a semicircular cross section corresponding to the outer shape of the conductor of the electrical wire 11. The shape of the groove 31a may have any other shape that can hold the electrical wire 11, and may have, for example, a V-shaped cross section.

The introducing portion 32 is a portion extending along the X direction and the Y direction, as in the introducing portion 31. The introducing portion 32 is located rearward in the X direction and downward in the Z direction relative to the introducing portion 31, and the introducing portions 31 and 32 are in staircase-like shape. The introducing portion 32 is provided with a plurality of grooves 32a (second grooves) on its upper surface. Each of the plurality of grooves 32a is formed in the Z direction as a depth direction, extends in the X direction, and is arranged along the Y direction. Each groove 32a is contiguously formed to lead to the corresponding holding hole 22b. The groove 32a accommodates and holds the electrical wire 11 introduced into the holding hole 22b, and guides the electrical wire 11. The groove 32a has, for example, a semicircular cross section corresponding to the outer shape of the conductor of the electrical wire 11, but may have another shape.

Each of the introducing portions 33 to 38 is a portion extending along the X direction and the Y direction, as in the introducing portions 31 and 32. Each of the introducing portions 33 to 38 is located rearward in the X direction and downward in the Z direction relative to the introducing portion 32, and a staircase-like shape is formed from the introducing portion 31 toward the introducing portion 38. Each of the introducing portions 33 to 38 has a plurality of grooves formed on an upper surface thereof. These grooves are contiguous to any of the corresponding holding holes 22c to 22h, and when the electrical wire 11 is inserted into the holding holes 22c to 22h, the electrical wire 11 is accommodated and held, and the electrical wire 11 is guided.

The stepped supporting portion 30 including the introducing portions 31–38 exhibits a staircase-like shape when viewed from the side. However, in the electrical connector 1, all the introducing portions 31–38 of the stepped supporting portion 30 are located in the housing back end portion 25.

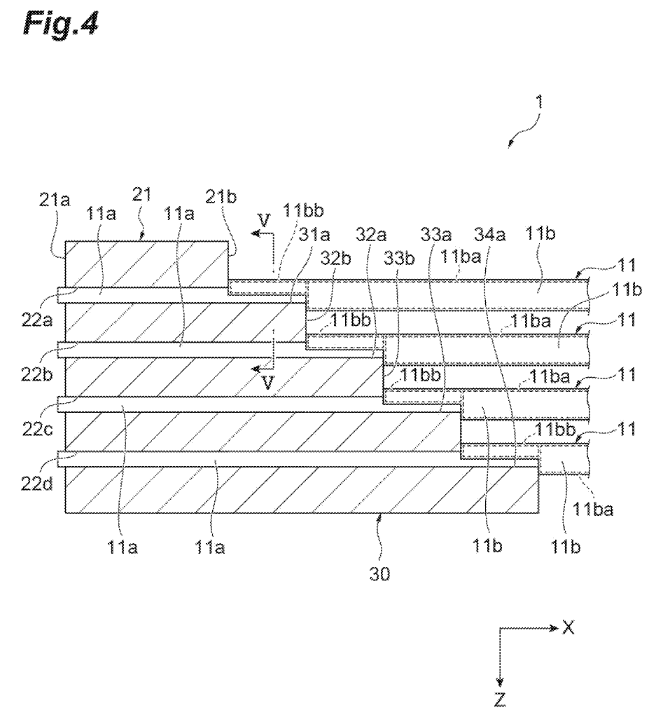

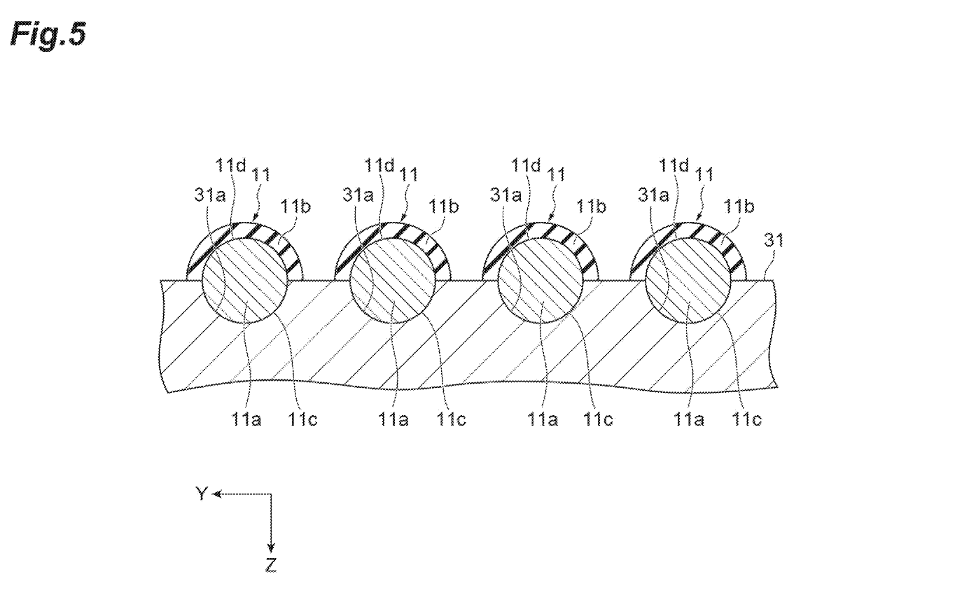

FIG. 4 is a cross-sectional view of a part of the stepped supporting portion 30, showing a conductor 11a of the electrical wire 11 inserted into each of the holding holes 22a to 22d. FIG. 5 is a cross-sectional view taken along line V-V of FIG. 4, showing a cross section of a portion of the electrical wire 11 accommodated in the groove 31a. As shown in FIGS. 4 and 5, the electrical wire 11 has the conductive conductor 11a and an insulating sheath 11b covering the conductor 11a. The conductor 11a is made of, for example, metal, and the insulating sheath 11b is made of, for example, resin.

The electrical wire 11 (first electrical wire) at the uppermost stage is accommodated and held in the groove 31a, and the conductor 11a thereof is introduced into the holding hole 22a. As described above, the holding hole 22a accommodates a portion of the conductor 11a exposed from the insulating sheath 11b at the tip end portion of the electrical wire 11, and holds the electrical wire 11 such that the tip end of the conductor 11a is exposed at the front end of the holding hole 22a. The electrical wire 11 (second electrical wire) at second stage is accommodated and held in the groove 32a, and the conductor 11a thereof is introduced into the holding hole 22b. The electrical wire 11 at third stage is accommodated and held in a groove 33a, and the conductor 11a thereof is introduced into the holding hole 22c. The electrical wire 11 at fourth stage is accommodated and held in a groove 34a, and the conductor 11a thereof is introduced into the holding hole 22d. Each of the holding holes 22b to 22d also accommodates the conductor 11a and holds the electrical wire 11, as in the holding hole 22a.

As shown in FIG. 5, the lower half of the insulating sheath 11b of the electrical wire 11 located at the groove 31a is removed. Thus, a side surface of the conductor 11a of the electrical wire 11 located at the groove 31a includes a first portion 11c accommodated inside the groove 31a, and the first portion 11c is exposed from the insulating sheath 11b and is in contact with the inner surface of the groove 31a. The side surface of the conductor 11a of the electrical wire 11 located at the groove 31a includes a second portion 11d located outside the groove 31a, and the second portion 11d is covered with the insulating sheath 11b. As in the electrical wire 11 located at each of the grooves 32a–34a, the first portion 11c accommodated inside the groove is exposed from the insulating sheath 11b, and the second portion 11d located outside the groove is covered with the insulating sheath 11b. “The portion accommodated inside the groove” means a portion facing an inner surface of the groove. “The portion located outside the groove” means a portion that does not face the inner surface of the groove and is exposed from the groove.

In an example shown in FIG. 5, the second portion 11d is entirely covered with the insulating sheath 11b. Thus, the insulating sheath 11b is in contact with the introducing portion 31, and the conductor 11a is completely covered with the insulator (the insulating sheath 11b and the introducing portion 31) in the circumferential direction. In other words, the conductor 11a is not exposed from the insulating sheath 11b or the introducing portion 31.

Reference is again made to FIG. 4. With the above structure, a portion 11ba of the insulating sheath 11b, which reaches any one of the grooves 31a–34a, covers the entire circumference of the conductor 11a. A portion 11bb of the insulating sheath 11b located at any of the grooves 31a–34a protrudes forward from the portion 11ba and covers a part (for example, a half circumference) of the conductor 11a in the circumferential direction.

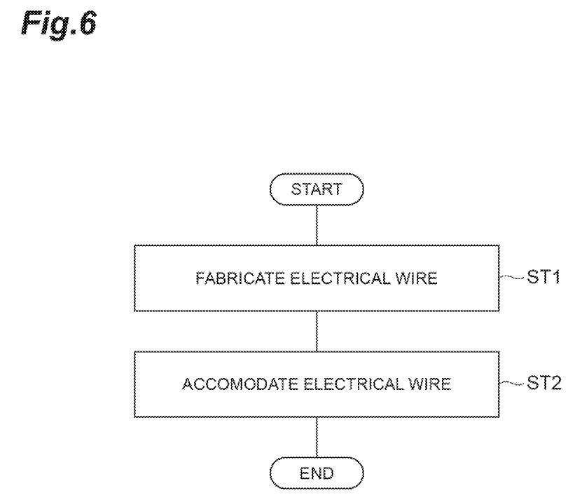

FIG. 6 is a flowchart showing an example of a method of manufacturing the electrical connector 1 according to the present embodiment. The manufacturing method includes a step ST1 of fabricating the electrical wire 11 and a step ST2 of accommodating the electrical wire 11. In the step ST1, the electrical wire 11 is fabricated. First, an electrical wire including the conductor 11a and the insulating sheath 11b covering the conductor 11a is prepared. Then, the insulating sheath 11b is removed from the tip end portion of the electrical wire 11 to expose the conductor 11a. At this time, the portion of the insulating sheath 11b covering the first portion 11c is removed while leaving the portion 11bb of the insulating sheath 11b covering the second portion 11d. Next, in the step ST2, the electrical wire 11 is accommodated in any one of the grooves 31a to 34a so that the first portion 11c is accommodated inside any one of the grooves 31a to 34a, and the conductor 11a of the tip end portion is inserted into any one of the holding holes 22b to 22d. According to this manufacturing method, the electrical wire 11 in which the first portion 11c accommodated inside the groove 31a is exposed from the insulating sheath 11b and the second portion 11d located outside the groove 31a is covered with the insulating sheath 11b can be easily fabricated.

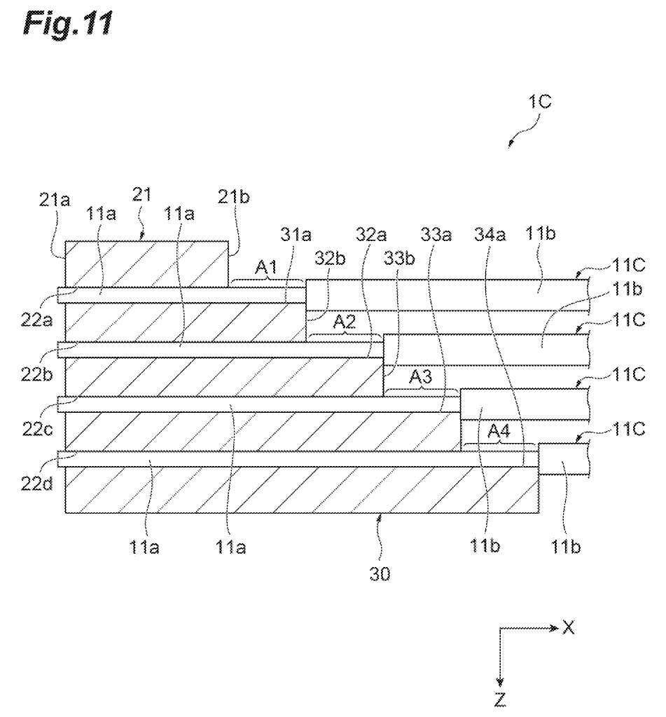

The effects obtained by the electrical connector 1 of the present embodiment having the above configuration will be described together with the problems of the electrical connector according to the comparative example. FIG. 11 is a cross-sectional view of an electrical connector 1C according to a comparative example. The electrical connector 1C includes electrical wires 11C instead of the plurality of electrical wires 11. In this electrical connector 1C, the insulating sheath 11b of the electrical wire 11C accommodated in the holding hole 22a is removed over the entire circumference in the entire region from the front end of the holding hole 22a to the back end of the groove 31a. The same applies to the electrical wire 11C accommodated in any of the holding holes 22b to 22d. In this case, a side surface of the conductor 11a exposed from the grooves 31a to 34a (regions A1–A4 shown in the drawing) is not covered with an insulator such as the insulating sheath 11b or the stepped supporting portion 30, and is exposed to air. Since the dielectric constant of the insulator is different from that of air, the impedance of the conductor 11a changes in the portion, which leads to deterioration of the characteristic impedance of the electrical wire 11C.

In order to solve the above problem, in the electrical connector 1 of the present embodiment, the side surface of the conductor 11a of the electrical wire 11 located at the groove 31a includes the second portion 11d located outside the groove 31a, and the second portion 11d is covered with the insulating sheath 11b. The same applies to the conductor 11a of the electrical wire 11 located at any of the grooves 31a–34a. This reduces the change in the impedance of the conductor 11a, thereby reducing the degree of deterioration or variation of the characteristic impedance of the electrical wire 11. In the example shown in FIG. 5, the second portion 11d in the circumferential direction is entirely covered with the insulating sheath 11b, but only a part of the second portion 11d in the circumferential direction may be covered with the insulating sheath 11b. Even in this case, the above-described effects can be achieved. In the present embodiment, the first portion 11c that is accommodated inside any of the grooves 31a–34a is exposed from the insulating sheath 11b. Thus, the conductor 11a can be accurately guided by the grooves 31a–34a.

As in the present embodiment, the housing 20 may be provided with the holding hole 22a extending along the X direction to pass through the housing 20. The holding hole 22a may have a back end contiguous to the groove 31a. The holding hole 22a may accommodate a portion of the conductor 11a exposed from the insulating sheath 11b at the tip end portion of the electrical wire 11, and may hold the electrical wire 11 such that the tip end of the conductor 11a is exposed at the front end of the holding hole 22a. In this case, the conductor 11a can be accurately guided to the holding hole 22a by the groove 31a. Thus, the assembling work of the electrical wire 11 and the housing 20 is facilitated.

As in the present embodiment, the housing 20 may be provided with the groove 32a for accommodating and holding the electrical wire 11 in addition to the groove 31a. In addition, the housing 20 may be provided with the holding hole 22b in addition to the holding hole 22a, and the holding hole 22b may be located in the Z direction relative to the holding hole 22a. The holding hole 22b may have a back end contiguous to the groove 32a. In this case, the conductor 11a can be accurately guided to the holding hole 22b by the groove 32a. Thus, the assembling work of the electrical wire 11 and the housing 20 is facilitated. In addition, the electrical wire 11 can be disposed over a plurality of stages. Thus, the packaging density of the electrical wires 11 can be increased, and the area of the board to which the electrical wires 11 are connected can be reduced.

### First Modification

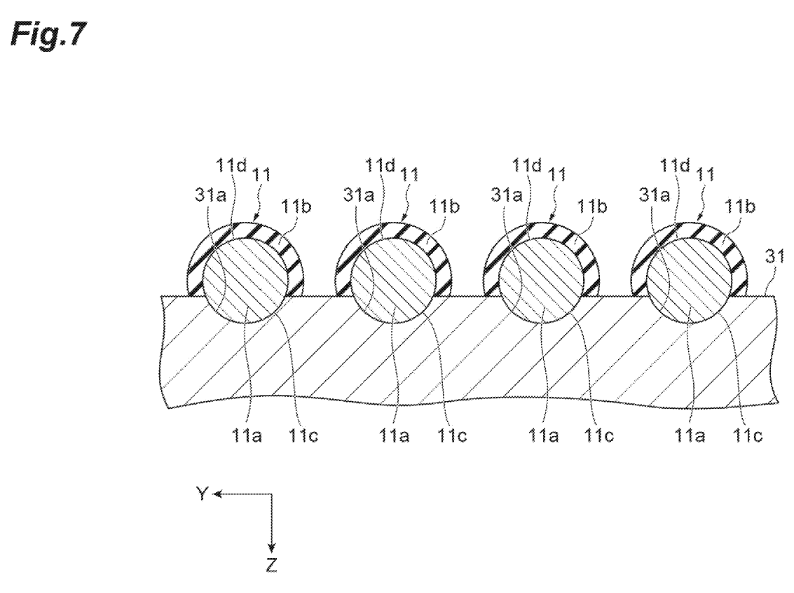

FIG. 7 is a cross-sectional view of the first modification of the present disclosure, showing a cross section of the portion of the electrical wire 11 accommodated in the groove 31a, perpendicular to the X direction. As shown in FIG. 7, in the present modification, a depth of the groove 31a is smaller than a radius of the conductor 11a. The groove 31a accommodates less than half the circumference of the side surface of the conductor 11a. In a cross section perpendicular to the X direction of the electrical wire 11, a length of a portion of an outer periphery of the conductor 11a covered with the insulating sheath 11b is longer than a length of a portion exposed from the insulating sheath 11b.

When the groove 31a is shallow, the second portion 11d located outside the groove 31a is larger than the first portion 11c accommodated in the groove 31a. In such a case, when the second portion 11d is exposed from the insulating sheath 11b, the change in the impedance of the conductor 11a becomes large, and the degree of deterioration or variation of the characteristic impedance of the electrical wire 11 becomes large. As in the present modification, the insulating sheath 11b is provided over a sufficient length of the outer periphery of the conductor 11a, so that the change in the impedance of the conductor 11a can be reduced, and the degree of deterioration or variation of the characteristic impedance of the electrical wire 11 can be reduced. The electrical wire 11 accommodated in the grooves 32a–34a has the same configuration as that of the present modification, and thus the same effect is obtained.

### Second Modification

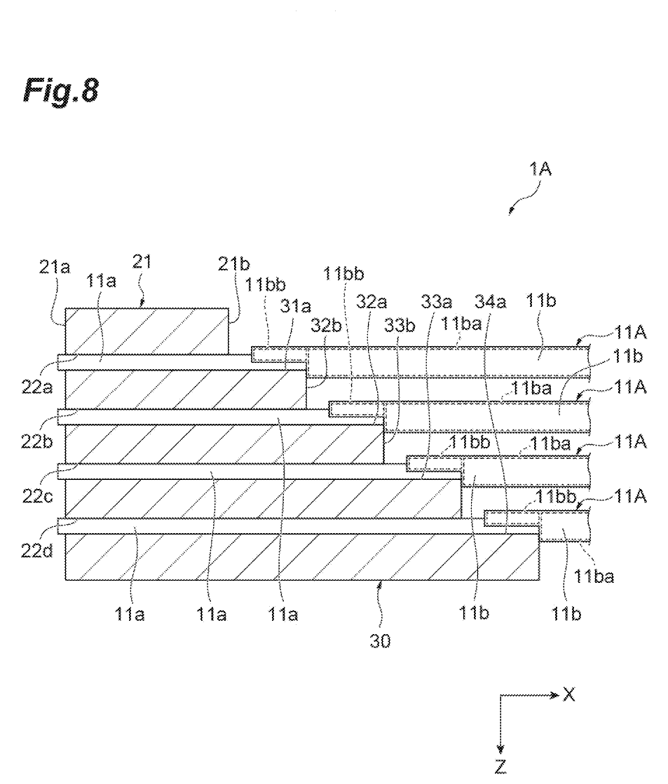

FIG. 8 is a cross-sectional view of an electrical connector 1A according to a second modification of the present disclosure. The electrical connector 1A includes a plurality of electrical wires 11A instead of the plurality of electrical wires 11 of the above embodiment. The electrical wire 11A differs from the electrical wire 11 in the following points. In the electrical wire 11 of the above embodiment, the entire area of the second portion 11d in the X direction is covered with the insulating sheath 11b, but in the electrical wire 11A of the present modification, only a part of the second portion 11d in the X direction is covered with the insulating sheath 11b as shown in FIG. 8. In other words, there is a gap between the portion 11ba of the insulating sheath 11b and the back surface 21b. Even in this case, the change in the impedance of the conductor 11a can be reduced and the degree of deterioration or variation of the characteristic impedance of the electrical wire 11 can be reduced as compared with the electrical connector 1C shown in FIG. 11. In the illustrated example, all the electrical wires 11A accommodated in the holding holes 22a to 22d have the above-described configuration, but only some of the plurality of electrical wires 11A accommodated in the holding holes 22a to 22d may have the above-described configuration.

### Third Modification

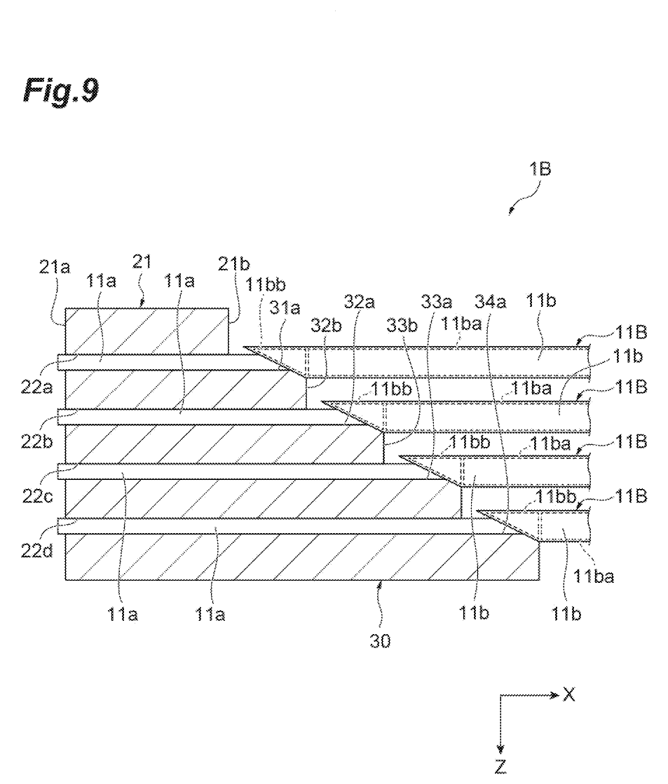

FIG. 9 is a cross-sectional view of an electrical connector 1B according to a third modification of the present disclosure. The electrical connector 1B includes a plurality of electrical wires 11B instead of the plurality of electrical wires 11 of the above embodiment. In the electrical wire 11B of present modification, a cross section of the insulating sheath 11b is inclined with respect to a plane perpendicular to the X direction, and a length of the portion 11bb of the insulating sheath 11b in the circumferential direction gradually increases toward each back end of the grooves 31a to 34a. In other words, the closer to the back ends of the grooves 31a–34a, the more the ratio of the second portion 11d that is sheathed by the insulating sheath 11b increases. In this manner, the length of the portion 11bb in the circumferential direction may change along the X direction. Even in this case, the change in the impedance of the conductor 11a can be reduced and the degree of deterioration or variation of the characteristic impedance of the electrical wire 11 can be reduced as compared with the electrical connector 1C shown in FIG. 11. In addition, the length of the portion 11bb in the circumferential direction gradually decreases from the groove 31a toward the front end of the groove 34a, and thus it is possible to reduce a rapid change in the impedance of the conductor 11a at the front end of the portion 11bb.

### Fourth Modification

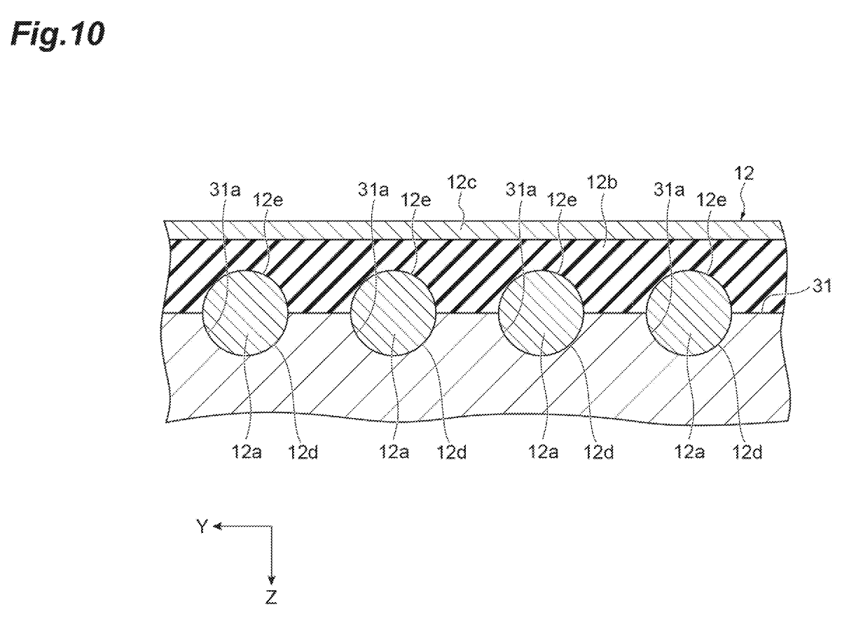

FIG. 10 is a cross-sectional view of a fourth modification of the present disclosure, showing a cross section of a flexible flat cable 12 disposed on the introducing portion 31, perpendicular to the X direction. As shown in FIG. 10, in present modification, the flexible flat cable 12 is disposed on the introducing portion 31 instead of the plurality of electrical wires 11. The flexible flat cable 12 includes an insulating sheath 12b, a conductive shield film 12c, and a plurality of conductors 12a extending along the X direction and arranged in the Y direction. In a portion of the flexible flat cable 12 that extends along the X direction reaches the introducing portion 31, the insulating sheath 12b collectively covers the plurality of conductors 12a, and the shield film 12c covers the outer periphery of the insulating sheath 12b. In the portion of the flexible flat cable 12 on or above the introducing portion 31, the lower half of the insulating sheath 12b is removed, and the plurality of conductors 12a are accommodated in the plurality of grooves 31a, respectively.

A side surface of the conductor 12a located at the groove 31a includes a first portion 12d, and the first portion 12d is accommodated inside the groove 31a and exposed from the insulating sheath 12b. The side surface of the conductor 12a located at the groove 31a includes a second portion 12e, and the second portion 12e is located outside the groove 31a and covered with the insulating sheath 12b. In an example shown in FIG. 10, the second portion 12e is entirely covered with the insulating sheath 12b. Thus, the insulating sheath 12b is in contact with the introducing portion 31, and the conductor 12a is completely covered with the insulator (the insulating sheath 12b and the introducing portion 31) in the circumferential direction. In other words, the conductor 12a is not exposed from the insulating sheath 12b or the introducing portion 31.

As in the present modification, the electrical wire may be the flexible flat cable 12. For example, in this manner, even in the electrical connector including the flexible flat cable 12, the change in the impedance of the conductor 12a can be reduced, and the degree of deterioration or variation of the characteristic impedance can be reduced. In the illustrated example, the cross section of the conductor 12a is circular. The cross section shape of the conductor 12a is not limited to this, and may be, for example, a rectangle. In this case, the cross section of the groove 31a may also be rectangular.

The electrical connector and the method of manufacturing the electrical connector according to the present disclosure are not limited to the above-described embodiments, and various modifications can be made. For example, the above embodiment and modification illustrate the electrical connector including a plurality of stages of the introducing portions 31–38. The electrical connector of the present disclosure is not limited to this configuration, and may include only one stage of the introducing portion. In the above embodiment and modification, the plurality of electrical wires 11 (or conductors 12a) is arranged in the Y direction, but only one electrical wire 11 (or conductor 12a) may be provided in the Y direction.

What is claimed is:

1. An electrical connector comprising:
a first electrical wire extending along a first direction and including a conductor and an insulating sheath covering the conductor; and
a housing provided with a first groove that extends along the first direction to accommodate and hold the first electrical wire, a depth direction of the first groove being a second direction intersecting the first direction,
wherein a side surface of the conductor of the first electrical wire located at the first groove includes a first portion accommodated inside the first groove and a second portion located outside the first groove, the first portion is exposed from the insulating sheath, and at least part of the second portion is covered with the insulating sheath.

2. The electrical connector according to claim 1,
wherein the housing is further provided with a first holding hole extending along the first direction to pass through the housing,
wherein the first holding hole has a first end contiguous to the first groove, and
wherein the first holding hole accommodates a portion of the conductor exposed from the insulating sheath at a tip end portion of the first electrical wire and holds the first electrical wire such that a tip end of the conductor is exposed at a second end of the first holding hole.

3. The electrical connector according to claim 2, further comprising:
a second electrical wire extending along the first direction and including a conductor and an insulating sheath covering the conductor,
wherein the housing is further provided with a second groove that extends along the first direction to accommodate and hold the second electrical wire, a depth direction of the second groove being the second direction,
wherein the housing is further provided with a second holding hole that extends along the first direction to pass through the housing, and the second holding hole is located in the second direction relative to the first holding hole,
wherein the second holding hole has a first end contiguous to the second groove, and
wherein a side surface of the conductor of the second electrical wire located at the second groove includes a first portion accommodated inside the second groove and a second portion located outside the second groove, the first portion is exposed from the insulating sheath, and at least part of the second portion is covered with the insulating sheath.

4. The electrical connector according to claim 1,
wherein the first electrical wire is a flexible flat cable.

5. The electrical connector according to claim 2,
wherein the first electrical wire is a flexible flat cable.

6. The electrical connector according to claim 3,
wherein the first electrical wire is a flexible flat cable.

7. The electrical connector according to claim 1,
wherein, in a cross section perpendicular to the first direction of the first electrical wire, a portion of an outer periphery of the conductor covered with the insulating sheath is longer than a portion of the outer periphery of the conductor exposed from the insulating sheath.

8. The electrical connector according to claim 2,
wherein, in a cross section perpendicular to the first direction of the first electrical wire, a portion of an outer periphery of the conductor covered with the insulating sheath is longer than a portion of the outer periphery of the conductor exposed from the insulating sheath.

9. The electrical connector according to claim 3,
wherein, in a cross section perpendicular to the first direction of the first electrical wire, a portion of an outer periphery of the conductor covered with the insulating sheath is longer than a portion of the outer periphery of the conductor exposed from the insulating sheath.

10. A method of manufacturing the electrical connector according to claim 1, the method comprising:
fabricating the first electrical wire by preparing an electrical wire including a conductor and an insulating sheath covering the conductor and by removing a portion of the insulating sheath covering the first portion while leaving a portion of the insulating sheath covering the at least part of the second portion; and
accommodating the first electrical wire in the first groove such that the first portion is accommodated inside the first groove.
